(19) United States
(12) Patent Application Publication
(10) Pub. No.: US 2012/0313929 A1
(43) Pub. Date: Dec. 13, 2012

(54) ELECTRONIC APPARATUS, CONTROL METHOD OF AN ELECTRONIC APPARATUS, AND COMPUTER-READABLE MEDIUM

(75) Inventor: Hideki Saito, Ageo-shi (JP)

(73) Assignee: KABUSHIKI KAISHA TOSHIBA, Tokyo (JP)

(21) Appl. No.: 13/428,274

(22) Filed: Mar. 23, 2012

(30) Foreign Application Priority Data
Jun. 10, 2011 (JP) 2011-130294

(51) Int. Cl. G06T 15/00

(52) U.S. Cl. 345/419

(57) ABSTRACT

According to one embodiment, an electronic apparatus includes an instruction receiver, a 3D depth information acquiring module, and a 3D display information output module. The instruction receiver receives an instruction to output GUI display information. The 3D depth information acquiring module acquires pieces of 3D-depth-related information corresponding to items to be displayed as a GUI display in response to the instruction. The 3D display information output module outputs GUI display information according to the acquired pieces of 3D-depth-related information so that at least part of the items to be displayed as a GUI display will be displayed in 3D if the acquired pieces of 3D-depth-related information comprises information corresponding to an item that should be displayed in 3D.

### CROSS REFERENCE TO RELATED APPLICATION(S)

This application is based upon and claims the benefit of priority from Japanese Patent Application No. 2011-130294 filed on Jun. 10, 2011, the entire contents of which are incorporated herein by reference.

### FIELD

Embodiments described herein relate generally to an electronic apparatus, a control method of an electronic apparatus, and a computer-readable medium.

### BACKGROUND

In recent years, electronic apparatus which use GUI (graphical user interface) display have been spreading. The GUI is a user interface which enables an intuitive operation using computer graphics and a pointing device.

Being superior in visibility and ease of operation, for example, and enabling an intuitive operation, GUI display is now widely used in various electronic apparatus such as personal computers (PCs), TV receivers, and portable video display apparatus.

However, electronic apparatus using GUI display are desired to be improved further in some points; for example, it is demanded to display, for example, items or the like to attract attention of a user with high visibility.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary view showing an appearance of an electronic apparatus according to an embodiment, which is a TV receiver;

FIG. 2 is an exemplary block diagram showing the configuration of the TV receiver according to the embodiment;

FIG. 3 is an exemplary table which contains pieces of 3D-depth-related information (priority levels and 3D depth levels) that are set in advance in the TV receiver according to the embodiment;

FIG. 4 is an exemplary view showing a setting change input picture through which an instruction relating to a setting change of 3D-depth-related information (priority and 3D depth) corresponding to items to be displayed by the TV receiver according to the embodiment can be input;

FIG. 5 is an exemplary table which contains pieces of 3D-depth-related information (priority levels and 3D depth levels) whose settings have been changed through the setting change input picture in the TV receiver according to the embodiment;

FIG. 6 is an exemplary view showing a GUI display (program table) which is displayed by the TV receiver according to the embodiment;

FIG. 7 is an exemplary flowchart of a process which is executed by the TV receiver according to the embodiment;

FIG. 8 is an exemplary view showing a table which contains priority levels and 3D depth levels for an initial setting menu (GUI display) that is set in advance in the TV receiver according to the embodiment;

FIG. 9 is an exemplary view showing a GUI display (initial setting menu) displayed on a video display module of the TV receiver according to the embodiment; and

FIG. 10 is an exemplary view showing a configuration of an electronic apparatus according to another embodiment.

### DETAILED DESCRIPTION

In general, according to one embodiment, an electronic apparatus includes an instruction receiver, a 3D depth information acquiring module, and a 3D display information output module. The instruction receiver receives an instruction to output GUI display information. The 3D depth information acquiring module acquires pieces of 3D-depth-related information corresponding to items to be displayed as a GUI display in response to the instruction. The 3D display information output module outputs GUI display information according to the acquired pieces of 3D-depth-related information so that at least part of the items to be displayed as a GUI display will be displayed in 3D if the acquired pieces of 3D-depth-related information comprises information corresponding to an item that should be displayed in 3D.

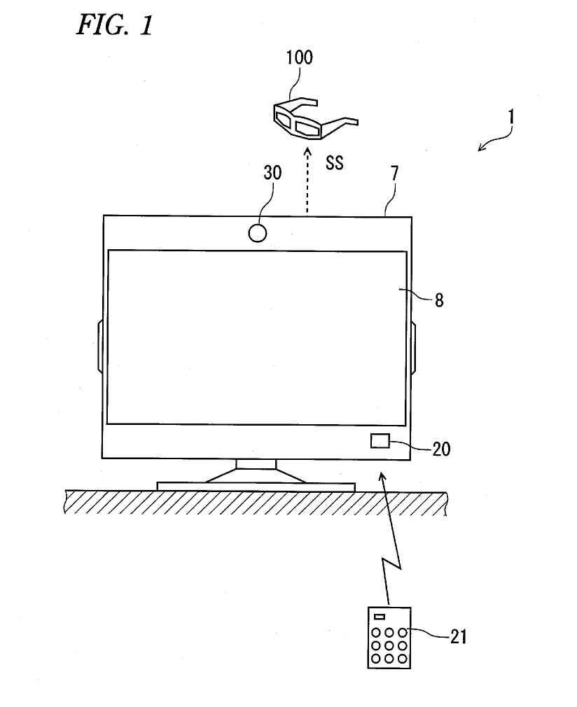

Exemplary embodiments will be hereinafter described with reference to the drawings. FIG. 1 shows an appearance of an electronic apparatus according to an embodiment, which is a TV receiver.

In recent years, electronic apparatus capable of displaying 3D video have been spreading. The term “3D” is an abbreviation of “three-dimensional” or “three dimensions,” and is used for referring to, for example, three-dimensional vision of video.

Although the embodiment is directed to the TV receiver as an example electronic apparatus, the invention can also be applied to other electronic apparatus such as personal computers (PCs) and portable video display apparatus.

For example, the TV receiver 1 receives, with a remote control signal receiver 20, a remote control signal that is transmitted from a remote controller 21 when it is operated by the user (viewer), and performs such an operation as video display.

The TV receiver 1 can display 3D video on a video display module (display screen) 8. For example, 3D video is pieces of video taken from different directions, that is, from the left side and the right side. Displayed 3D video is viewed by the user (viewer) who wears the 3D glasses 100.

Although the embodiment is directed to a case of viewing 3D video using the 3D glasses 100, the invention can also be applied to naked-eye 3D viewing which does not use 3D glasses.

For example, the 3D glasses 100 incorporate liquid crystal shutters and receive a sync signal SS from the TV receiver 1. Shutter control is performed in the 3D glasses 100 using the sync signal SS.

In the embodiment, for example, the TV receiver 1 incorporates a camera 30 and uses it for detection of a person. For example, the camera 30 which is used for detection of a person is disposed near the video display module 8. The camera 30 may be disposed in the video display module 8.

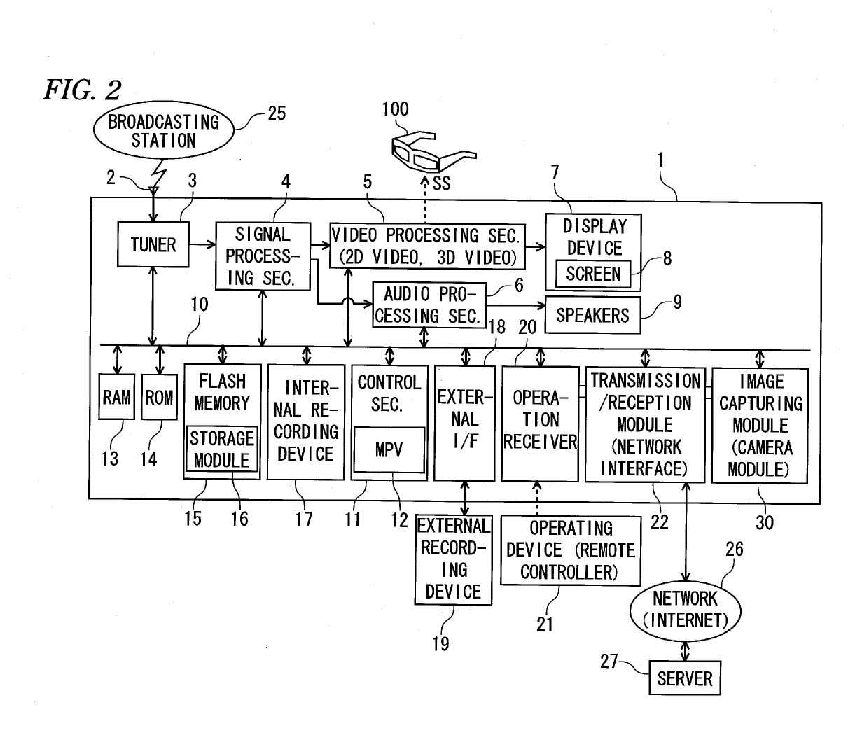

FIG. 2 is a block diagram showing the configuration of the TV receiver 1 according to the embodiment. Reference numeral 2 denotes an antenna; 3, a tuner; 4, a signal processor; 5, a video processor; 6, an audio processor; 7, a display device; 8, the display screen (video display module); 9, speakers; 10, a bus; 11, a controller; 12, an MPU; 13, a RAM; 14, a ROM; 15, a flash memory; 16, a storage module; 17, an internal recording device; and 18, an external interface. Reference numeral 19 denotes an external recording device to be connected to the external interface 18.

Reference numeral 20 denotes an operation receiver; 21, the remote controller; 22, a transmitting/receiving module (network interface); 25, broadcasting stations; 26, a network (Internet); and 27, a server.

The controller 11 has the MPU 12 and controls the TV receiver 1. The RAM 13, the ROM 14, and the flash memory 15 are used for processing that is performed by the controller 11, for example.

For example, digital broadcasts of video contents are broadcast from the broadcasting stations 25. The tuner 3 tunes in to one of the digital broadcasts that are transmitted from the broadcasting stations 25, and outputs a digital signal of the selected video content to the signal processor 4.

The signal processor 4 performs signal processing on the digital signal of the selected video content, and outputs resulting signals to the audio processor 6 and the video processor 5.

The audio processor 6 performs audio processing on the received signal of the video content and outputs resulting signals to the speakers 9. The speakers 9 produce a sound on the basis of the received signals.

The video processor 5 performs video processing on the received signal of the video content and outputs a resulting signal to the display device 7. The display device 7 displays video on the display screen (video display module) 8 of an LCD panel or the like on the basis of the received signal.

In the embodiment, the TV receiver 1 has the internal recording device 17 and can record the received video content there.

In the embodiment, the external recording device 19 is USB-connected or LAN-connected to the TV receiver 1. The received video content can also be recorded in the external recording device 19.

The user inputs an operation (instruction) to the TV receiver 1 through the operation device 21 such as a remote controller.

The above pieces of processing are controlled by the controller 11.

When connected to the server 27 through the transmitting/receiving module (network interface) 22, the TV receiver 1 can, for example, receive Web page and perform browsing.

In the embodiment, the TV receiver 1 outputs a sync signal SS that is generated by the video processor 5, for example. As described above, the sync signal SS is received by the 3D glasses 100 and used by the user (viewer) wearing the 3D glasses 100 to view 3D video.

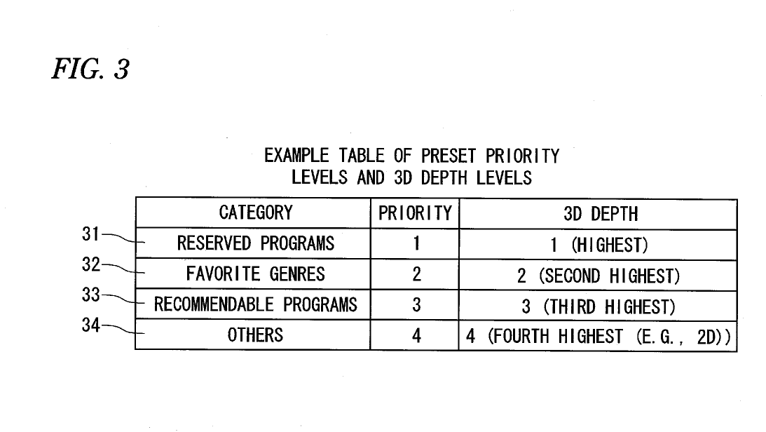

FIG. 3 shows an example table which contains pieces of 3D-depth-related information (priority levels and 3D depth levels) that are set in advance in the TV receiver 1 according to the embodiment.

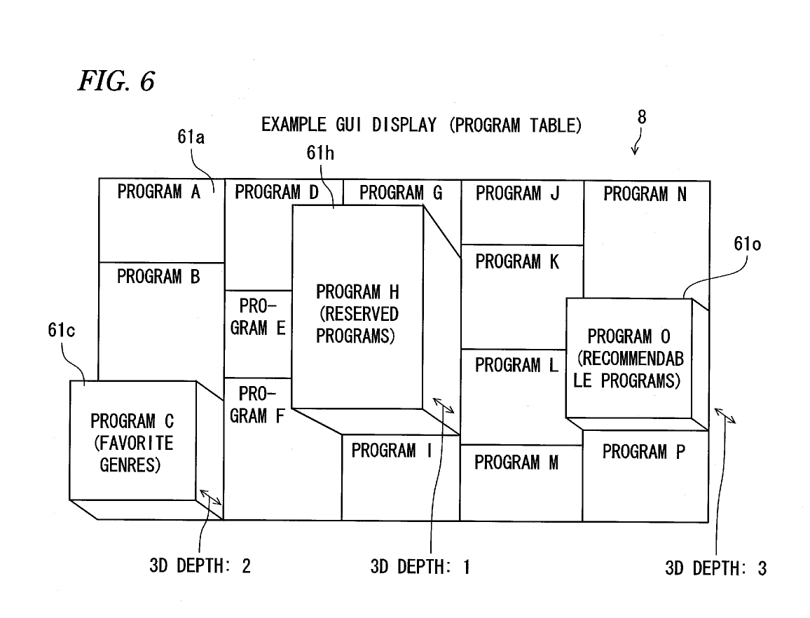

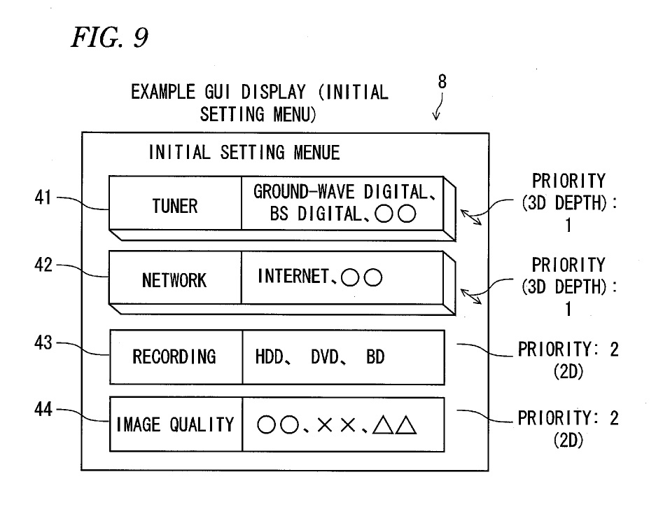

In the embodiment, for example, items that are high in priority are given high 3D depth levels (i.e., displayed high) and items that are low in priority are given low 3D depth levels (i.e., displayed low). More specifically, the TV receiver 1 makes a GUI display in a manner to be described later with reference to FIG. 6 or 9.

For example, the TV receiver 1 receives an instruction to make a GUI display from the user. In response to the display instruction, the TV receiver 1 acquires pieces of 3D-depth-related information corresponding to items to be displayed as a GUI display. If the acquired pieces of 3D-depth-related information include information corresponding to an item(s) that should be displayed in 3D, the TV receiver 1 makes a GUI display in such a manner that that item is displayed in 3D.

In the embodiment, for example, as shown in FIG. 3, a table is formed in such a manner that each category is correlated with priority and 3D depth.

In the table of FIG. 3, a category “reserved programs” 31 is given priority “1” and 3D depth “1.” In this example, when the priority is “1,” the 3D depth is given a level “1,” which means that corresponding items (in this example, items of the corresponding category) should be displayed highest in 3D display.

A category “favorite genres” 32 is given priority “2” and 3D depth “2.” In this example, when the priority is “2,” the 3D depth is given a level “2,” which means that the corresponding item (in this example, the corresponding category) should be displayed second highest in 3D display.

A category “recommendable programs” 33 is given priority “3” and 3D depth “3.” In this example, when the priority is “3,” the 3D depth is given a level “3,” which means that corresponding items (in this example, items of the corresponding category) should be displayed third highest in 3D display.

A category “others” 34 is given priority “4” and 3D depth “4.” In this example, when the priority is “4,” the 3D depth is given a level “4,” which means that corresponding items (in this example, items of the corresponding category) should be displayed fourth highest in 3D display. Since the 3D depth “4” is the lowest level, the corresponding items (in this example, the items of the corresponding category “others”) may be displayed at a zero height, that is, in 2D.

The pieces of information of the table are stored in the storage module 16 of the flash memory 15, for example.

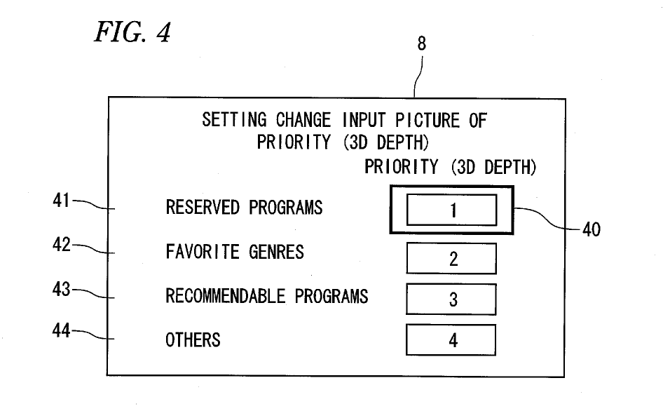

FIG. 4 shows an example setting change input picture through which an instruction relating to a setting change of 3D-depth-related information (priority and 3D depth) corresponding to items to be displayed by the TV receiver 1 according to the embodiment can be input.

This setting change input picture is displayed on the video display module 8 of the TV receiver 1.

While looking at this setting change input picture, the user can input an instruction relating to a setting change of a preset piece of 3D-depth-related information (priority and 3D depth) in a manner shown in FIG. 3 by operating the remote controller 21, for example.

For example, to change the setting of the 3D-depth-related information (priority and 3D depth) of the category “reserved programs” 41, the user moves a cursor 40 to the position where the setting should be changed and inputs a new piece of 3D-depth-related information (priority and 3D depth).

Likewise, to change the setting of the 3D-depth-related information (priority and 3D depth) of the categories “favorite genres” 42, “recommendable programs” 43, or “others” 44, the user moves the cursor 40 to the position where the setting should be changed and inputs a new piece of 3D-depth-related information (priority and 3D depth).

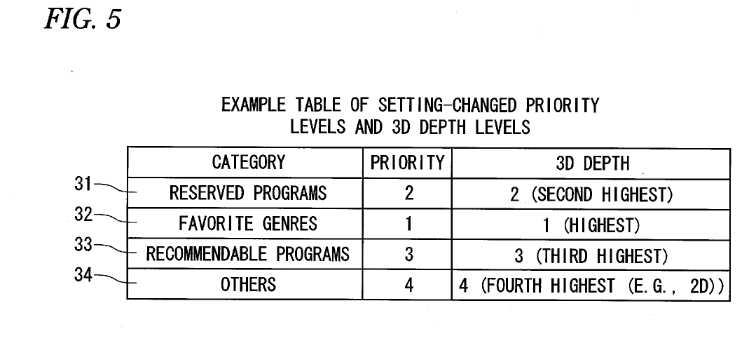

FIG. 5 shows an example table which contains pieces of 3D-depth-related information (priority levels and 3D depth levels) whose settings have been changed through the setting change input picture of FIG. 4 in the TV receiver 1 according to the embodiment.

In the embodiment, 3D-depth-related information (priority and 3D depth) is changed in the above-described manner.

Like the table of FIG. 3, a table is formed in such a manner that each category is correlated with priority and 3D depth.

More specifically, the priority and the 3D depth of the category “reserved programs” 31 are each changed to “2.” The 3D depth “2” means that corresponding items (i.e., items of the corresponding category) should be second highest in 3D display.

The priority and the 3D depth of the category “favorite genres” 32 are each changed to “1.” The 3D depth “1” means that corresponding items (i.e., items of the corresponding category) should be highest in 3D display.

The 3D-depth-related information (priority and 3D depth) of each of the categories “recommendable programs” 33 and “others” 34 is not changed. That is, the priority and the 3D depth of the category “recommendable programs” 33 each remain “3,” and the priority and the 3D depth of the category “others” 34 each remain “4.”

The pieces of information of the table are also stored in the storage module 16 of the flash memory 15, for example.

FIG. 6 shows an example GUI display (program table) which is displayed by the TV receiver 1 according to the embodiment. This GUI display (program table) is displayed on the video display module 8 of the TV receiver 1.

In the embodiment, as described above with reference to FIG. 3, categories of, for example, items to attract attention of the user of the program table to be displayed as a GUI display are stored in the storage module 16 of the flash memory 15, for example, so as to be correlated with pieces of 3D-related information. In response to an instruction to make a GUI display (i.e., to display a program table), pieces of 3D-depth-related information corresponding to items to be displayed as a GUI display are acquired from the storage module 16 of the flash memory 15.

If the acquired pieces of 3D-depth-related information include (pieces of) information (e.g., 3D depth “1,” “2,” or “3”) to the effect that corresponding items should be display in 3D, as shown in FIG. 6 items are displayed as a GUI display (program table) according to the acquired pieces of 3D-depth-related information in such a manner that part of them are displayed in 3D.

In this example, as shown in FIG. 3, the priority and the 3D depth of the category “reserved programs” are each set at “1.” The priority and the 3D depth of the category “favorite genres” are each set at “2.” The priority and the 3D depth of the category “recommendable programs” are each set at “3.” The priority and the 3D depth of the category “others” are each set at “4.” Since the 3D depth “4” is the lowest level, corresponding items may be displayed in 2D.

If the 3D depth levels of all the acquired pieces of 3D-depth-related information are “4,” it may be judged that they do not include information to the effect that corresponding items should be displayed in 3D.

For example, in this example, “program H” 61h is categorized as “reserved programs.” Since the priority and the 3D depth of the category “reserved programs” are each set at “1,” as shown in FIG. 6 this item (“program H” 61h) is displayed highest in 3D.

“Program C” 61c is categorized as “favorite genres.” Since the priority and the 3D depth of the category “favorite genres” are each set at “2,” as shown in FIG. 6 this item (“program C” 61c) is displayed second highest in 3D.

“Program O” 61o is categorized as “recommendable programs.” Since the priority and the 3D depth of the category “recommendable programs” are each set at “3,” as shown in FIG. 6 this item (“program O” 61o) is displayed third highest in 3D.

“Program A” 61a is categorized as “others.” Since the priority and the 3D depth of the category “others” are each set at “4,” as shown in FIG. 6 this item (“program A” 61a) is displayed fourth highest in 3D. Since the 3D depth “4” is the lowest level, this item may be displayed in 2D.

In the GUI display of FIG. 6, the items “program H” 61h (categorized as “reserved programs”), “program C” 61c (categorized as “favorite genres”), and “program O” 61o (categorized as “recommendable programs”) are displayed in 3D in descending order of 3D depth and the item “program A” (categorized as “others”) is displayed in 2D. The item “program A” may be displayed fourth highest in 3D.

That is, in this GUI display (program table), the items “program H” 61h (categorized as “reserved programs”), “program C” 61c (categorized as “favorite genres”), and “program O” 61o (categorized as “recommendable programs”) are items to attract attention of the user.

For example, a technique is known which increases user visibility by setting the display areas of prescribed items of a GUI display (program table). However, with this technique, the information amount of a GUI display (program table) may decrease.

In contrast, by virtue of the above manner of display, the embodiment can prevent such decrease in information amount.

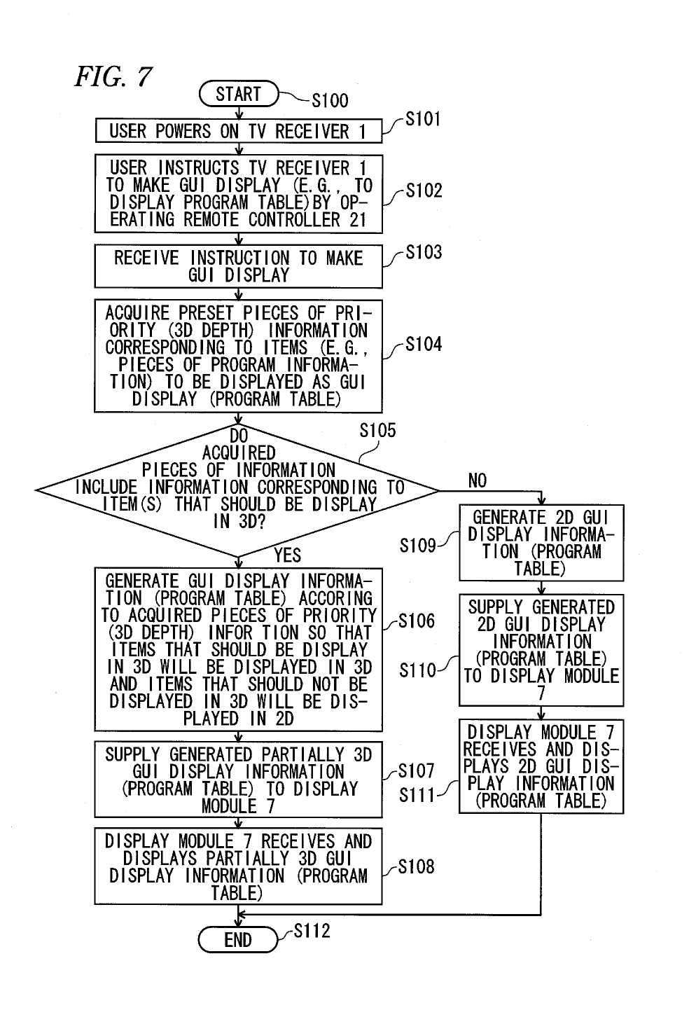

FIG. 7 is a flowchart of a process which is executed by the TV receiver 1 according to the embodiment. The process starts at step S100. At step S101, the TV receiver 1 is powered on. At step S102, the user instructs the TV receiver 1 to make a GUI display (e.g., to display a program table) by, for example, operating the remote controller 21.

At step S103, the TV receiver 1 receives the instruction to make a GUI display. At step S104, pieces of priority (3D depth) information that are stored in advance in, for example, the flash memory 15 so as to be correlated with items (e.g., pieces of program information) to be displayed as a GUI display (program table) are acquired.

At step S105, it is judged whether the acquired pieces of priority (3D depth) information include information corresponding to an item(s) that should be displayed in 3D. For example, if the acquired pieces of priority (3D depth) information include 3D depth “1,” “2,” or “3” (see FIG. 6), it is judged that they include information corresponding to an item(s) that should be displayed in 3D. If all the acquired pieces of priority (3D depth) information are at the level “4,” it is judged that they do not include information corresponding to an item(s) that should be displayed in 3D.

If it is judged that the acquired pieces of priority (3D depth) information include information corresponding to an item(s) that should be displayed in 3D (S105: yes), the process moves to step S106. On the other hand, if it is judged that the acquired pieces of priority (3D depth) information do not include information corresponding to an item(s) that should be displayed in 3D (S105: no), the process moves to step S109.

At step S106, GUI display information (program table) is generated according to the acquired pieces of priority (3D depth) information so that the items that should be displayed in 3D will be displayed in 3D and the items that should not be displayed in 3D will be displayed in 2D.

At step S107, the generated partially 3D GUI display information (program table) is supplied to the display module 7. At step S108, the display module 7 receives and displays the partially 3D GUI display information (program table).

At step S109, 2D GUI display information (program table) is generated in the above-described manner. At step S110, the generated 2D GUI display information (program table) is supplied to the display module 7. At step S111, the display module 7 receives and displays the 2D GUI display information (program table). The process is finished at step S112.

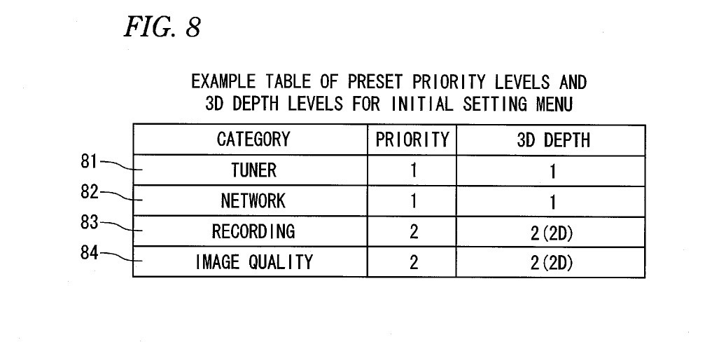

FIG. 8 shows an example table which contains priority levels and 3D depth levels for an initial setting menu (GUI display) that is set in advance in the TV receiver 1 according to the embodiment. As shown in FIG. 8, the priority and the 3D depth of a category “tuner” 81 are each set at “1.” The priority and the 3D depth of a category “network” 82 are each set at “1.” The priority and the 3D depth of a category “recording” 83 are each set at “2.” The priority and the 3D depth of a category “others” 84 are each set at “2.” Since the 3D depth “2” is the lowest level, corresponding items may be displayed in 2D.

In the embodiment, as described above, categories of, for example, items to attract attention of the user of the initial setting menu (GUI display) are stored in the storage module 16 of the flash memory 15, for example, so as to be correlated with pieces of 3D-related information.

FIG. 9 shows an example GUI display (initial setting menu) displayed on the video display module 8 of the TV receiver 1 according to the embodiment. In the embodiment, as described above with reference to FIG. 8, categories of, for example, items to attract attention of the user of the initial setting menu (GUI display) are stored in the storage module 16 of the flash memory 15, for example, so as to be correlated with pieces of 3D-related information.

In response to an instruction to make a GUI display (i.e., to display an initial setting menu), pieces of 3D-depth-related information corresponding to items to be displayed as a GUI display are acquired from the storage module 16 of the flash memory 15.

If the acquired pieces of 3D-depth-related information include information (e.g., 3D depth “1”) corresponding to an item(s) that should be displayed in 3D, as shown in FIG. 9 items are displayed as a GUI display (initial setting menu) according to the acquired pieces of 3D-depth-related information in such a manner that part of them are displayed in 3D.

For example, since the priority and the 3D depth of the category “tuner” are each set at “1,” as shown in FIG. 9 the corresponding item 41 is displayed highest in 3D.

The item 41 corresponding to the category “tuner” is displayed in such a manner as to urge the user to select this item. This item indicates that selection can be made from “ground-wave digital,” “BS digital,” and “◯◯.”

Since the priority and the 3D depth of the category “network” are each set at “1,” as shown in FIG. 9 the corresponding item 42 is displayed highest in 3D.

The item 42 corresponding to the category “network” is displayed in such a manner as to urge the user to select this item. This item indicates that selection can be made from “Internet” and “◯◯.”

Since the priority and the 3D depth of the category “recording” are each set at “2,” as shown in FIG. 9 the corresponding item 43 may be displayed in 2D, for example.

The item 43 corresponding to the category “recording” is displayed in such a manner as to urge the user to select this item. This item indicates that selection can be made from “HDD,” “DVD” and “BD.”

Since the priority and the 3D depth of the category “image quality” are each set at “2,” the corresponding item 44 may be displayed in 2D, for example.

The item 44 corresponding to the category “image quality” is displayed in such a manner as to urge the user to select this item. This item indicates that selection can be made from “◯◯,” “ΔΔ” and “xx.”

In this GUI display (initial setting menu), the items 41 and 42 corresponding to the categories “tuner” and “network” are displayed in 3D as shown in FIG. 9 to indicate that they are items to attract attention of the user.

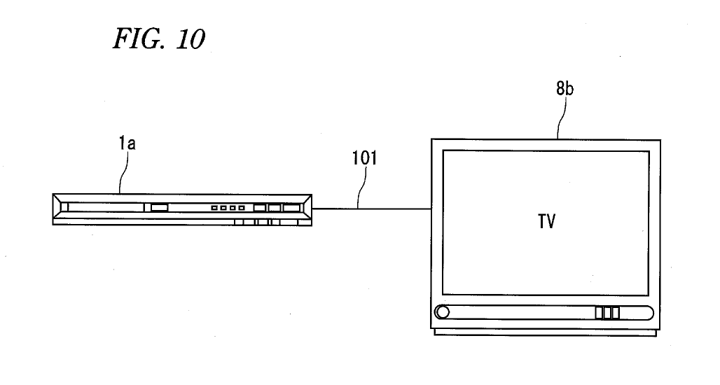

FIG. 10 shows the configuration of an electronic apparatus according to another embodiment, which is a BD (Blu-ray Disc) recorder. In this embodiment, as shown in FIG. 10, a TV receiver 8b having a display module is connected to the BD recorder 1a by an HDMI cable 101.

The BD recorder 1a outputs GUI display information as described above. The TV receiver 8b receives the GUI display information from the BD recorder 1a and makes a GUI display on its video display module in the same manner as described above.

With the above configuration, this embodiment makes it possible to provide an electronic apparatus which utilizes GUI display and can display, for example, items to attract attention of the user with high visibility.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and method, described herein may be made without departing from the sprit of the invention. The accompanying claims and their equivalents are intended to cover such forms or modifications as would fall within the scope and sprit of the invention.

What is claimed is:

1. An electronic apparatus comprising:
an instruction receiver configured to receive an instruction to output GUI display information;
a 3D depth information module configured to acquire 3D-depth-related information corresponding to items to be displayed as a GUI display in response to the instruction; and
a 3D display information module configured to output GUI display information related to the acquired 3D-depth-related information so that at least part of the items to be displayed as a GUI display will be displayed in 3D when the acquired 3D-depth-related information comprises information corresponding to an item that should be displayed in 3D.

2. The apparatus of claim 1, wherein the 3D-depth-related information comprises at least first and second 3D depth levels.

3. The apparatus of claim 1, wherein when the acquired 3D-depth-related information comprises information corresponding to an item that should not be displayed in 3D, the 3D display information module is configured to output GUI display information so that the item will be displayed in 2D.

4. The apparatus of claim 1, wherein when the acquired 3D-depth-related information does not comprise information corresponding to an item that should be displayed in 3D, the 3D display information module is configured to output GUI display information so that all of the items to be displayed as a GUI display will be displayed in 2D.

5. The apparatus of claim 1, wherein the 3D-depth-related information is set in advance.

6. The apparatus of claim 5, further comprising a setting changer configured to change settings of the 3D-depth-related information.

7. The apparatus of claim 1, wherein the GUI display is a program table.

8. The apparatus of claim 7, wherein the GUI display comprises 3D display items and 2D display items.

9. The apparatus of claim 1, wherein the GUI display is a setting menu.

10. The apparatus of claim 1, further comprising a display configured to display the output GUI display information.

11. The apparatus of claim 1, wherein the 3D-depth-related information comprises priority levels corresponding to the items to be displayed as a GUI display.

12. A method of controlling an electronic apparatus comprising:
receiving an instruction to output GUI display information;
acquiring 3D-depth-related information corresponding to items to be displayed as a GUI display in response to the instruction; and
outputting GUI display information related to the acquired 3D-depth-related information so that at least part of the items to be displayed as a GUI display will be displayed in 3D when the acquired 3D-depth-related information comprises information corresponding to an item that should be displayed in 3D.

13. A non-transitory computer-readable medium storing a program for causing the computer to perform operations comprising:
receiving an instruction to output GUI display information;
acquiring 3D-depth-related information corresponding to items to be displayed as a GUI display in response to the instruction; and
outputting GUI display information related to the acquired 3D-depth-related information so that at least part of the items to be displayed as a GUI display will be displayed in 3D when the acquired 3D-depth-related information comprises information corresponding to an item that should be displayed in 3D.
